(19) United States
(12) Patent Application Publication
(10) Pub. No.: US 2014/0279255 A1
(43) Pub. Date: Sep. 18, 2014

(54) SYSTEM AND METHOD FOR LAYERED VISUALIZATION OF POINTS OF INTEREST DATA

(71) Applicants: Aaron Kardell, St. Paul, MN (US); Nathan Kadlac, Minneapolis, MN (US)

(72) Inventors: Aaron Kardell, St. Paul, MN (US); Nathan Kadlac, Minneapolis, MN (US)

(21) Appl. No.: 13/841,300

(22) Filed: Mar. 15, 2013

(51) Int. Cl. G06Q 50/16; G06Q 30/06

(52) U.S. Cl. CPC G06Q 50/16; G06Q 30/0625
USPC 705/26.62

(57) ABSTRACT

A system and method for layered visualization of points of interest data may include receiving an indication of a search location; presenting a user interface on a display device of a computing device, the user interface including: indicia representing a plurality of property listings overlaid on a map according to the search location; and a list view of the plurality of property listings overlaid on the map, wherein each property listing in the list view includes an image associated with a property listing of the plurality of property listing; receiving an input gesture on an image of a first property listing, of the plurality of property listings, in the list view; and in response to receiving the input gesture presenting a second image of the first property listing in the list view.

### BACKGROUND

Multiple Listing Service (MLS) publish listings of retail properties that are currently for sale. Each local market may have a separate MLS database that may be queried. A user using a mobile device (e.g., smart phones or tablet) may run applications on the device that interacts with the MLS data. For example, a real estate searching application may be used to look for homes for sale in the user's area.

### BRIEF DESCRIPTION OF THE DRAWINGS

Some embodiments are illustrated by way of example and not limitation in the figures of the accompanying drawings in which:

FIG. 1 is an example system diagram of a computing device requesting property listings, according to an example;

FIGS. 2-11 are user interfaces of a property listing searching application, according to various examples;

FIG. 12 is a flow diagram of an example method of using a properly listing searching application;

FIG. 13 is a flow diagram of an example method of receiving updated property listings;

FIG. 14 is a flow diagram of an example method of querying a database;

FIG. 15 is a flow diagram of an example method of sending updated property listings; and

FIG. 16 shows a diagrammatic representation of a machine in the example form of a computer system within which a set of instructions for causing the machine to perform any one or more of the methods, processes, operations, or methodologies discussed herein may be executed.

### DETAILED DESCRIPTION

The following detailed description includes references to the accompanying drawings, which form a part of the detailed description. The drawings show, by way of illustration, specific embodiments in which the invention may be practiced. These embodiments, which are also referred to herein as “examples,” are illustrated in enough detail to enable those skilled in the art to practice the invention. The embodiments may be combined, other embodiments may be utilized, or structural, logical, and electrical changes may be made without departing from the scope of the present invention. The following detailed description is, therefore, not to be taken in a limiting sense, and the scope of the present invention is defined by the appended claims and their equivalents. In this document, the terms “a” or “an” are used, as is common in patent documents, to include one or more than one.

Touch-enabled computing devices (e.g., mobile phones, tablets, laptops, desktop personal computers) have enabled new ways (e.g., input gestures) for users to interact with user interfaces. For example, swiping gestures may allow a user to “slide” parts of a user interface in and out of focus. A user may use a pinching motion using two finger on a screen to zoom-in, for example, on a map or use a swiping gesture to move to a new location in the map.

In various examples, a map-based application (e.g., a property listing searching application) is presented to user on a computing device for navigating points-of-interest (POI) data in a layered approach. Points-of-interests may include, but are not limited to, real estate listings, historical places, food & drink, gas stations, sports facilities, lodging, entertainment, and shopping locations. Each POI may include a location (e.g., geo-coordinates such as GPS coordinates, address, etc.). Further, each POI may have one or more types (e.g., attribute) of data associated with the POI depending on the POI type. For examples, a real estate listing POI may have associated listing information such as price, number of bedrooms, and number of bedrooms.

In addition to having a touch interface, a computing device may include a location sensor, such as a GPS sensor. Applications running on the computing device may determine a location of the computing device by way of the location sensor and use it to customize the application. For example, a user may be executing a real estate searching application which uses GPS data to determine which listings to display on the computing device.

In an example, listings of homes (e.g., for sale, recently sold, estimated worth) with location information are already stored on the computing device. This may obviate the need to query an external network with the GPS data before any results may be returned. By storing listings of homes with location information, an increase in the speed in which results are shown may be obtained, and wireless bandwidth usage may be reduced. In addition, increased privacy may be provided to users by not transmitting their location to remote servers.

In other examples, the listing information is not pre-stored on the computing device, but instead is retrieved based on an as-needed basis. For example, after a user conducts a search in a given area, a request with location information and search criteria (e.g., the location selected by the user, GPS data, price-range, etc.) may be transmitted to a server for listings that match the location and search criteria. The results may be transmitted back to the computing device for display to the user and/or further processing by the application. Attribute data of the listings may be retrieved at the time of the request or retrieved from a further request (e.g., a user clicks on a listing to view more details).

FIG. 1 is an example system 100 of a computing device requesting and retrieving updated property listings, according to an example embodiment. The property listings may be shown in a layered interface as described further below (see e.g., FIG. 2). Also, while FIG. 1 is discussed with respect to real estate property listings, other types of POIs and their associated data (e.g., movie theater locations and movie times for the movies playing at the locations) may be retrieved in a similar fashion.

In an example, system 100 includes computing device 102, Application Delivery Server 104, Listing Server 106, and MLS server 108. In an embodiment, a points-of-interest application (e.g., a property listing searching application) is stored on the computing device. The property listing searching application may be downloaded from the Application Delivery Server through network 110 (e.g., the Internet).

In an example, a user of computing device 102 launches the property searching application on the computing device to begin a search of property listings. In an embodiment, when the user downloads the property searching application, the download includes a set of property listing entries. Each property listing entry may include an identification data field and a location coordinate data field (e.g., longitude and latitude). Upon launching the application, the property searching application may send a request to Listing Server 106 for updated property listing entries. The updated property listing entries may include instructions to add, modify, or delete existing property listing entries on the computing device.

FIG. 2 illustrates an example user interface 200 of a properly listing searching application. FIG. 2 includes map 202, search box 204, current location tool 206, filter tool 208, indicia 210, and listing view tool 212. In various embodiments, upon launching the property listing searching application (e.g., a user selecting the application from a plurality of applications on user interface) a search area to use with the property searching application is determined. For example, the search area may be determined according to a GPS reading of the computing device. Before using the GPS, the application may prompt the user to use the current location or a user may “activate” (e.g., click) current location tool 206 to instruct the application to use the current location.

In an embodiment, the search area is determined according to the bounds of a map displayed on the user's screen. For example, the user may navigate to a location that is different than his or her physical location. The search area may be considered the center of the map displayed on the computing device's screen. In an embodiment, the search area is updated when the boundaries of the displayed map change (e.g., user input such as scrolling, zooming the map, or the location of the computing device changes). In an embodiment, the search area is initially set according to what a user enters into search box 204. For example, a user may enter a city name, postal code, address, or MLS listing number. In an embodiment, the search area is determined according to a polygon search area the user draws on the computing device's screen (e.g., using a finger, touch-enabled stylus, etc.). Thus, the search area may be smaller than what is displayed on the display of the computing device.

In an embodiment, properties located within the search area may be represented as indicia 210 (e.g., icons, shapes, symbols, text, etc.) and displayed on map 202. For example, the search area may be the area within the bounds of the map displayed on the user's screen. In an embodiment, coordinates within the search area are compared with the location coordinates or addresses of the property listing entries (e.g., on the computing device or external server), and matching properties within the search area are represented as indicia on the map according to their locations. A user may select one of the representations (e.g., the indicia) to retrieve detailed attributes about the selected property. The search area may be updated as discussed above. In various embodiments, the search area is defined by a distance away from a specified location (e.g., locations within ten miles of the location of the computing device).

In various embodiments, attribute information of a property (also referred to as property attributes) may be stored in more than one level of detail. For example, attribute information may be stored as a range (e.g., $250,000 to $300,000 if the attribute is the price of a home) or as a single value ($279,230). In an embodiment, when the attribute information is stored as a range of values the attribute information may be considered partial attribute information. When the attribute information is stored as a single value it may be considered detailed attribute information.

In various embodiments, a combination of partial and detailed attribute information may be stored in a listing database on the computing device (in a flat file or relational database). The attribute information may be associated with a property listing entry. In an embodiment, the computing device initially has partial attribute information, but no detailed attribute information. In an embodiment, the partial attribute information is kept up-to-date.

As needed detailed attribute information may be retrieved from the listing server by sending the identification of a property to Listing Server 106. For example, detailed attributed information may be received for a selected representation of a property to Listing Server 106. In various embodiments, the database is updated with the detailed attribute information. In an embodiment, the detailed attribute information replaces the partial attribute information when it is received from Listing Server 106. In an embodiment, the partial attribute information is stored alongside the detailed attribute information.

In an embodiment, detailed attribute information is pre-fetched (e.g., requested from the listing server) and stored in the database before a user selects one of the representations. The amount of detailed attribute information pre-fetched may be determined according to some of the user's search criteria as well as what is already stored in the database. For example, consider a user searching for homes that are below $250,000, but the database has partial attribute information indicating a range of $200,000 to $300,000. The computing device may send a request for detailed attribute information on all homes within this range to determine whether or not a home falls within the user's price criteria. However, the computing device may not need to send a request for detailed attribute information for homes that have partial attribute information indicating a range of $150,000 to $200,000. In an embodiment, detailed attribute information is retrieved for all properties located within the search area.

Attribute information may include price information, address information, number of bedrooms, number of bathrooms, status (e.g. active, sold, foreclosed, etc.), type (e.g. single family, condo, etc.), square footage, year built, and whether or not the property is a featured property. In various embodiments, attribute information includes image files of the property listing. In various embodiments, attribute information includes open house information. In various embodiments, attribute information includes the MLS listing number. The attributes may have varying levels of detail. For example, partial open house information may be stored as yes/no, whereas detailed open house information may be stored as the time and date of the open house. Partial address information may include a zip-code where as detailed address information includes the entire address. In various embodiments, the partial and detailed attribute information are the same (e.g., whether or not a property is a featured property).

In various embodiments, computing device 102 includes a processor, display, network interface, memory, one or more applications stored on the memory, location determination hardware, and an input interface. The display may be non-touch, a capacitive touchscreen, or a resistive touchscreen. In the case of using a touchscreen, the display can also be used as an input interface. Other input interfaces may include a keyboard, a stylus, gesture control, or voice control. Network interfaces include interfaces capable of receiving and sending data such as wireless interfaces CDMA, GSM, WI-FI, WiMAX, or wired interface such as Ethernet or USB. The location determination hardware may include, but is not limited to, GPS, Assisted GPS, cell tower based location determination, Wi-Fi access points, or RFID based location determinations. The processor executes instructions stored on the memory to provide the functionality described herein. In various embodiments, computing device 102 is a tablet based computer.

In various embodiments, Application Delivery Server 104, Listing Server 106, and MLS Server 108 include a processor, display, network interface, memory, one or more applications stored on the memory, and an input interface. Input interfaces may include touchscreens, a keyboard, a stylus, gesture control, or voice control. Network interfaces include interfaces capable of receiving and sending data such as wireless interfaces CDMA, GSM, WI-FI, WiMAX, or wired interface such as Ethernet or USB. The processor executed instructions stored on the memory to provide the functionality described herein. In various embodiments, Application Delivery Server 104, Listing Server 106, and MLS Server 108 are personal computers. In various embodiments, Application Delivery Server 104, Listing Server 106, and MLS Server 108 are configured as servers without displays such that the servers are controlled remotely via protocols such as HTTP or SSH.

In various embodiments, MLS Server 108 stores a set of property listing entries in a database. MLS Server 108 may store localized versions of a set of property listing entries. For example, MLS Server 108 may store property listing entries associated with residential homes for sale in the Minneapolis, Minn. market. Each listing entry may include one or more data fields that store attribute information about a residential property listing. For example, attribute information may include, but is not limited to, an identification number, an address, longitude and latitude coordinates, number of bedrooms, number of bathrooms, square footage, date added to the MLS listings, and sales price. In various embodiments, the entries are stored using a database management system (DBMS), a flat file database, or XML.

In various embodiments, Listing Server 106 communicates with MLS Server 108 to store the set of property listing entries. Listing Server 106 may also store partial and detailed attribute information for the property listings. In addition to the set of property listing entries, Listing Server 106 may also maintain data associated with application identities of downloads of the property searching application. In various embodiments, the application identity may be a serial number, a version number, or a timestamp that indicates the time of a download of the property searching application or the last time property listings were updated. Thus, in various embodiments, the property searching application may be identified through the use of timestamp or version number of the property searching application stored on the computing device. In various embodiments using a timestamp or version number there is no need to have an application uniquely identified.

In various embodiments, Listing Server 106 may maintain an application identifier for each download of the property searching application. When a request from a computing device is received, Listing Server 106 is able to retrieve data associated with that specific download of the property searching application. The data associated with a download may include the location of the download (e.g., Minneapolis) and the last time a request was made for property listing entries for that specific property searching application.

In various embodiments, Application Delivery Server 104 is responsible for responding to a request for downloads of applications which are transmitted to computing devices. In an embodiment, Application Deliver Server 104 is configured to host many types of applications (e.g., games, reference, and searching applications). In an embodiment, Application Delivery Server 104 is configured to be responsible only for property searching applications. For example, Application Delivery Server 104 may store different sets of property listing entries for the various location based versions of a property searching application. In an embodiment, Application Delivery Server 104 may store multiple branded versions of property listing entries (e.g., multiple local brokers might each have different sets of property listing entries). In an embodiment, if a user requests the Minneapolis version of the property searching application, an initial set of Minneapolis based property listings may be transmitted with the property searching application. Furthermore, Application Delivery Server 104 may transmit a notification to Listing Server 106 with an identification of the application with the time the property searching application was downloaded. In an embodiment, Application Delivery Server 104 may transmit a notification to Listing Server 106 with an identification of the version or timestamp of the property searching application downloaded. In an embodiment, the download of the application is delivered to computing devices with a version or timestamp identifying the version of the listing database, which obviates the need for the Application Delivery Server 104 to transmit a notification to Listing Server 106.

While Application Delivery Server 104, Listing Server 106, and MLS Server 108 are illustrated as distinct servers, in other embodiments these servers may be combined on one physical machine or the functionality may be distributed across multiple physical machines beyond those illustrated. For example, the functionality described for Listing Server 106 and Application Delivery Server 104 may be housed in one machine.

With reference back to FIG. 2, once the properly listing searching application has been loaded and an initial set of property listings determined according to a search area, a user may begin to interact with the retrieved data. For example, a user may activate filter tool 208 to conduct a more granular search of property listing data.

In an example, FIG. 3 illustrates search options 302 that may be available to a user to filter search results shown on map 202 after activating filter tool 208. In various examples, the search options relate to attribute data of the property listing. After a user has selected one or more search options and activates “Done” button 304, the properly listing searching application may query the listing database of the computing device or transmit a request to an external server to determine matching property listings. Map 202 may then be updated to remove or add indicia representing the property listings that match the user's search criteria and are within the search area.

FIG. 4 illustrates an example user interface 400 of the properly listing searching application. Interface 400 includes a selected property listing represented by indicia 414. A user may select a property by clicking the indicia. For example, a user may make contact/press with the touchscreen in the location of the indicia. The operating system of the computing device may relay the location of the press to the properly listing searching application and the properly listing searching application may determine (e.g., correlate the location of the press with the coordinates of a displayed indicia) that the location of the press corresponds to a particular properly listing overlaid on the map.

In an example, a selected indicia may be visually modified/highlighted when selected. For example, the indicia may be presented in a different color, different shape, different line width, different size, etc. An overview of the attributes of the selected property listing may be presented in overview display 402 that includes image data 404 (e.g., a picture of the property), price 406, address 408, number of bedrooms 408, number of bathrooms 410, and square feet 412. In various examples, the number and type of attributes displayed in overview display 402 may change (e.g., age of the home, lot size, etc., may be displayed). The attribute information may be retrieved from the listing database on the computing device or may be retrieved from an external server (e.g., listing server 106).

FIG. 5 illustrates an example user interface 500 of the properly listing searching application and displays another way to view attribute information of property listings. Interface 500 does not include any selected property listings, but does include an example list view 502 with a single column of listings that is overlaid on map 202. List view 502 may be displayed by a user using a swiping gesture on listing view tool 212. For example, a user may press a finger on listing view tool 212 and, while maintaining contact with a touchscreen of the computing device, drag his or her finger left and then lift his or her finger up. List view 502 includes an overview of attribute data for a number of property listings. The order of the property listings in the list view may be changed by the user using a sort option such as sorting tool 504 (e.g., clicking the sort tool may present different criteria to sort the property listings). In an example, listing view tool 212 may not be shown to a user, but instead is activated when a user makes contact within a predefined region of the screen (e.g., a border of 15 pixels from the right side of the display).

In various examples, depending on how far the user's finger is in contact with the touchscreen (after starting with a selection of listing view tool 212 or predefined region) a different list view may be presented with different numbers of columns (see e.g., FIGS. 8 and 9). Accordingly, properly listing searching application may have different thresholds for each list view. For example, with respect to FIG. 5, the touchscreen may be divided into multiple regions. The first region may include approximately the right one-quarter of the screen; the second region may include approximately the second-to-right quarter of the screen; and the third region includes approximately the left-hand side of the screen. As may be appreciated, these regions are for illustration purposes and other divisions of a screen may be used. As such, properly listing searching application may receive an indication of which region the user's finger was removed from with a beginning point of the listing view tool and present the list view corresponding to the region.

In various examples, the location of the list view may be changed. For example, the list view tool may be placed on the bottom of the interface and, therefore, the list view may slide over the map from the bottom of the screen. Accordingly, the specific directions of the swiping gestures as discussed herein may change if the location of the list view changes (e.g., with respect to FIG. 6, a gesture to the left using close tool 606 may be used if the list view is on the right of the screen).

In an example, a user may use an input gestures (e.g., swipe up or down) on a list view to see additional property listings. For example, FIG. 5 states there are 24 properties found, but list view 502 only shows four. A user may make contact with the touchscreen within list view 502 and drag up or down to see additional property listings. In an example, while the user the user is dragging, a scroll indicator may appear on the display indicating the relative distance and location within the list of properties.

FIG. 6 illustrates an example user interface 600 of the properly listing searching application. Similarly to FIG. 5, a list view 602 is presented, but in interface 600 a property listing has been selected. As illustrated, the selected property listing may be highlighted in both list view 602 and on map 202. Within list view 602, highlighting may include changing the background color and extending the property listing to cover more of the map. Additionally, image data 604 of the property listing may be enlarged. In various examples, a user may click on a property listing in list view 602 or on indicia on the map to select a property. Upon such as selection, the indicia and list view 602 may be updated to highlight the selected property (including scrolling the list view if necessary).

A user may close list view 602 by swiping (e.g., pressing and moving his or her finger) to the right with a starting point of close tool 606. Upon receiving indication of such a gesture, the interface of the properly listing searching application may change back to one such as illustrated in FIG. 4 with the selected property listing still selected on the map with its accompanying overview.

In various examples, image data that is displayed on the interfaces of properly listing searching application may be directly interacted with by the user. For example, when image data of a property is displayed, such as image data 604, a user may use an input gesture such as swiping (e.g., make contact with the image and move left or right before lifting off the touch screen) the image itself to advance to another image of the property listing. In various examples, a user may click the right or left hand side of an image to advance forward or backward, respectively, to another image of the property.

FIG. 7 illustrates an example user interface 700 that displays what a user may see while swiping an image. As illustrated, part of image data 702 is shown at the same image data 604 is shown. Thus, a wipe transition may be achieved. Other transitions may be used as well as a user moves through a set of images of a property. FIG. 7 also illustrates a numerical indication of how many pictures there are for a property listing and where in the list the user is currently (704). In various examples, the indication may be shown temporarily (e.g., one second) as the user advances from one image to the next. If the user reaches the end of the list, a further swipe on the image may take the user back to the first image for the property listing. While the above has been discussed with respect to list view 602, a user may interact with image data in other views as well (e.g., list views 802 and 902 with respect to FIGS. 8 and 9).

FIGS. 8 and 9 illustrate example interfaces 800/900 with list views 802 and 902 respectively. As discussed previously, different list views may be presented depending on where a user drags list view tool 212. Accordingly, FIG. 8 illustrates list view 802 in which two columns of property listings are displayed and list view 902 illustrates list view 902 in which four columns of property listing are displayed. The use of two columns and four columns is illustrative in nature and other arrangements of the listings may be used. In an example, a tool may be presented to the user to allow more or less listings to be shown (e.g., changing the size of the listings). A user may switch between the various list views by dragging and releasing list view tool 212. Properly listing searching application may receive an indication of where the tool was released and show the appropriate list view.

FIG. 10 illustrates an example user interface 1000 of a properly listing searching application. As illustrated, interface 1000 includes three visible layers. Detailed view 1002 is overlaid on listing view 902 which in turn is overlaid on the map. In various examples, a user may be presented with a view, such as detailed view 1002, of a property listing by clicking on the property listing (e.g., a user may click on a listing in a list view, including an image, or click on overview display 402).

Detailed view 1002 includes image data 1004, image indicators 1006, and listing overview 1008. In an example, image data 1004 is a higher resolution version of an image of the property listing than in the list views. Image indicators 1006 may indicate how many photos of a property listing are present and which image the user is currently viewing (e.g., by highlighting the indicator). In an example, textual indicators (e.g., “1 of 16”) may also be used. A user may use an input gesture on image data 1004 to traverse other images of the property listing.

In an example, a user may use an input gesture on detailed view 1002 to retrieve additional attribute data about the property listing. For example, a user may use a swipe-up gesture (e.g., pressing the touchscreen and moving upwards on the screen before releasing) to be presented with an interface such as interface 1100 of FIG. 11. A user may then use a swipe-down gesture on the listing to be brought back to an interface such as user interface 1000.

In various examples, a user may use an input gesture (e.g., swipe-right) on detailed view 1002 to close the detailed view and be taken back to the user's previous view. For example, if a user clicked on a property listing while using a two-column list view such as illustrated in FIG. 8, the user may be presented with a two-column list view after closing (e.g., swiping away) the detailed view layer.

FIG. 12 illustrates a flow diagram of an example method of using a properly listing searching application. In an example, an indication of a search location is received in a properly listing searching application of a computing device (1202). For example, a user may enter a search location into an input box (e.g., search area 204) or GPS sensor data may be read.

In an example, a user interface may be presented (e.g., displayed) on a screen of the computing device (1204). The interface may include indicia representing a plurality of property listings overlaid on a map according to the search location. For example, location information of the property listings may be correlated with the search area to determine relevant property listings. The interface may also include a list view of the plurality of property listings overlaid on the map, wherein each property listing in the list view includes an image associated with a property listing of the plurality of property listing.

In an example, an input gesture may be received on an image of a first property listing, of the plurality of property listings, in the list view (1206). For example, the properly listing searching application may receive an indication that a user has swiped the image data. In an example, in response to the input gesture, a second image of the first property listing may be presented in the list view (1208).

FIG. 13 is an example method of receiving updated property listings, according to an example embodiment. In an embodiment, at block 1302, a set of property listing entries are stored in a database of a computing device, wherein a property listing entry includes an identification data field and a location coordinate data field. Additionally, detailed property attributes may be stored in one or more data fields of a property listing entry, wherein the detailed property attributes include square footage, address, and a number of bedrooms. Partial property attributes may include compressed (e.g., ranges) versions of detailed property attributes. For example, partial property attributes may include a price range. Varying amounts of detail may be stored for each property listing entry. For example, a computing device may initially store attributes that are commonly searched by users (whether partial or detailed—e.g., a listing price range of $150,000-$225,000 or a listing price of $194,900). If additional or more detailed attribute information is requested for a specific property, a request may be made to a listing server to retrieve the additional or detailed attribute information. This may be accomplished, for example, by transmitting information stored in the identification data field of the one or more property listing entries to the listing server. In some embodiments, information related to a listing agent may be stored in the property listing entry.

In an example embodiment, at block 1304, a property searching application is executed on a processor of the computing device. The application may be received as described with respect to FIG. 1. In various embodiments, a property searching application is branded such that contact information is included in the download of the property searching application. Thus, the user may be directed towards a specific agency or person for scheduling a showing for a specific property.

In an example embodiment, at block 1306, updated property listing entries are received, via a network interface of the computing device, from a listing server. At block 1308, the set of property listing entries is transformed based on the updated property listings. Updated listing, in an embodiment, may include changes to existing property listing entries, additional property listing entries, and instructions to remove existing property listing entries. The request for updated property listing entries may be initiated in a number of ways including, application launch, user request, periodic (e.g., daily), or when a certain type of network interface is detected (e.g., WI-FI or USB). In an embodiment, the updated property listing entry may include updated partial or detailed attribute information associated with a property listing entry.

FIG. 14 is an example method of querying a database to retrieve property listings. In an example embodiment, at block 210, a search area is determined. For example, the search area may be determined according to the location of the computing device. In an embodiment, the search area is determined according to the bounds of a map displayed on the computing device. In an embodiment, a user may input a search location to use as the basis for the search area and the search may not be dependent on the location of the computing device.

At block 1412, the database is queried to retrieve one or more property listing entries from the set of property listing entries based on a comparison between the search area and the location coordinate data fields of the property listing entries. In an embodiment, querying a database includes accessing a database with criteria to retrieve property entries matching the criteria. For example, if the database is a relational database, an SQL statement may be generated using the search area as an input criteria. If the database is a flat file, the flat file may be traversed to look for entries that have location coordinates within the search area. In an embodiment, user search preferences of property attributes may be received and the one or more property listing entries may be filtered according to the user preferences. For example, a user search preference may indicate a price range or square footage range. Property listing entries outside of the user preferences may be filtered out of the matched properties (e.g., the properties determined to be within the search area).

At block 1414, in an embodiment, the database may be queried to determine if detailed attribute information is available for the retrieved one or more property listing entries. For example, it may be determined that some of the property listing entries only have partial attribute information. In various embodiments, some of the attributes of a property listing entry may have partial attribute information while others have detailed attribute information. For the property listing entries that do not have detailed attribute information stored in the database, at block 1416, the detailed attribute information may be downloaded from a listing server and the property listing entries may be updated.

At block 1418, representations of the one or more property listing entries are displayed on the display device in the form of a map. In various embodiments, the one or more property listing entries are displayed in a list or table format. The property searching application may present various starting user interfaces. For example, the sequence just described is one where the user is presented with a map of property listings currently in his or her area. However, in a different embodiment, the application may launch with a search interface that a user can enter property attributes that are of interest (square footage, price range, bedrooms, etc.) and matching results are filtered before being displayed on a map.

FIG. 15 is an example method of sending updated property listings, according to an example embodiment. At block 1502, in an example embodiment, a set of property listing entries are stored in a listing database. The property listings may be periodically updated from a multiple listing services database.

In various embodiments, attributes of a property stored on the listing server may be a superset of the attributes of the property listing stored on a computing device. For example, the types of bathrooms may be stored on the listing server while only the total number of bathrooms is stored on the computing device. In another example embodiment, media associated with a property listing is maintained on the listing server and is available upon request (e.g., photos of a residential property). In yet another embodiment, the information stored on the computing device may be compressed and stored as partial attribute information. For example, price information may be stored as a range on the computing device (e.g., 25 k ranges, 100-125 k, 126-150 k, etc.). Similarly, addresses stored on the computing device may only include city and zip code. In other embodiments, a property listing entry on the listing server is identical to one stored on the computing device.

In an example embodiment, at block 1504, a set of application identification entries are stored in an application database, wherein an application identification identifies a download of a listing database for a property searching application. At block 1506, in an example embodiment, a request is received from a computing device for updated property listing entries, wherein the request includes an application identification. At block 1508, in an example embodiment, changes in property listing entries already stored on the computing device since a last request for updated property listing entries from the computing device are determined based on the received application identification.

By having a unique identification of each application download a listing server can track indirectly which property listing entries are currently stored on the computing device. This may be done through the use of timestamps being associated with each request for updated property listing entries. A listing server may only need to look at changes to property listings after the last time-stamped entry. In an embodiment, a unique identification of each application is not needed. Instead, an application identification may be received from the computing device that indicates the last time the computing device updated its property listings. Thus, a compare may be done to determine what listings have changed after the timestamp.

In an example embodiment, at block 1510, a response message is formatted, wherein the response message includes a list of property listing entries to delete from the computing device and wherein the response message includes additional property listing entries added after the last request. The response message may also include property listings to modify. The formatting may specify an identification of a property listing entry and an action to take. In an example embodiment, at block 1512, the response message is transmitted to the computing device. In an embodiment, the response message may compress latitude and longitude of one or more property listing entries based on clusters of nearby property entries.

### A Computer System

FIG. 16 shows a diagrammatic representation of a machine in the example form of a computer system 1600 within which a set of instructions for causing the machine to perform any one or more of the methods, processes, operations, or methodologies discussed herein may be executed. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a Personal Computer (PC), a tablet PC, a Set-Top Box (STB), a Personal Digital Assistant (PDA), a cellular telephone, a Web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein. Example embodiments can also be practiced in distributed system environments where local and remote computer systems which are linked (e.g., either by hardwired, wireless, or a combination of hardwired and wireless connections) through a network, both perform tasks. In a distributed system environment, program modules may be located in both local and remote memory-storage devices (see below).

The example computer system 1600 includes a processor 1602 (e.g., a Central Processing Unit (CPU), a Graphics Processing Unit (GPU) or both), a main memory 1601 and a static memory 1606, which communicate with each other via a bus 1608. The computer system 1600 may further include a video display unit 1610 (e.g., a Liquid Crystal Display (LCD) or a Cathode Ray Tube (CRT)). The computer system 1600 also includes an alphanumeric input device 1612 (e.g., a keyboard), a User Interface (UI) cursor controller 1614 (e.g., a mouse), a disk drive unit 1616, a signal generation device 1618 (e.g., a speaker) and a network interface device 1620 (e.g., a transmitter).

The disk drive unit 1616 includes a machine-readable medium 1622 on which is stored one or more sets of instructions 1624 and data structures (e.g., software) embodying or used by any one or more of the methodologies or functions illustrated herein. The software may also reside, completely or at least partially, within the main memory 1601 and/or within the processor 1602 during execution thereof by the computer system 1600, the main memory 1601 and the processor 1602 also constituting machine-readable media.

The instructions 1624 may further be transmitted or received over a network 1626 via the network interface device 1620 using any one of a number of well-known transfer protocols (e.g., HTTP, Session Initiation Protocol (SIP)).

The term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding, or carrying a set of instructions for execution by the machine and that cause the machine to perform any of the one or more of the methodologies illustrated herein. The term “machine-readable medium” shall accordingly be taken to include, but not be limited to, solid-state memories, and optical and magnetic medium.

Method embodiments illustrated herein may be computer-implemented. Some embodiments may include computer-readable media encoded with a computer program (e.g., software), which includes instructions operable to cause an electronic device to perform methods of various embodiments. A software implementation (or computer-implemented method) may include microcode, assembly language code, or a higher-level language code, which further may include computer readable instructions for performing various methods. The code may form portions of computer program products. Further, the code may be tangibly stored on one or more volatile or non-volatile computer-readable media during execution or at other times. These computer-readable media may include, but are not limited to, hard disks, removable magnetic disks, removable optical disks (e.g., compact disks and digital video disks), magnetic cassettes, memory cards or sticks, Random Access Memories (RAMs), Read Only Memories (ROMs), and the like.

The various embodiments described herein may be implemented including logic or a number of components, modules, or mechanisms. Modules may constitute either software modules (e.g., code embodied (1) on a non-transitory machine-readable medium or (2) in a transmission signal) or hardware-implemented modules. A hardware-implemented module is tangible unit capable of performing certain operations and may be configured or arranged in a certain manner. In example embodiments, one or more computer systems (e.g., a standalone, client or server computer system) or one or more processors may be configured by software (e.g., an application or application portion) as a hardware-implemented module that operates to perform certain operations as described herein.

In various embodiments, a hardware-implemented module may be implemented mechanically or electronically. For example, a hardware-implemented module may comprise dedicated circuitry or logic that is permanently configured (e.g., as a special-purpose processor, such as a field programmable gate array (FPGA) or an application-specific integrated circuit (ASIC)) to perform certain operations. A hardware-implemented module may also comprise programmable logic or circuitry (e.g., as encompassed within a general-purpose processor or other programmable processor) that is temporarily configured by software to perform certain operations. It will be appreciated that the decision to implement a hardware-implemented module mechanically, in dedicated and permanently configured circuitry, or in temporarily configured circuitry (e.g., configured by software) may be driven by cost and time considerations.

Accordingly, the term “hardware-implemented module” should be understood to encompass a tangible entity, be that an entity that is physically constructed, permanently configured (e.g., hardwired) or temporarily or transitorily configured (e.g., programmed) to operate in a certain manner and/or to perform certain operations described herein. Considering embodiments in which hardware-implemented modules are temporarily configured (e.g., programmed), each of the hardware-implemented modules need not be configured or instantiated at any one instance in time. For example, where the hardware-implemented modules comprise a general-purpose processor configured using software, the general-purpose processor may be configured as respective different hardware-implemented modules at different times. Software may accordingly configure a processor, for example, to constitute a particular hardware-implemented module at one instance of time and to constitute a different hardware-implemented module at a different instance of time.

Hardware-implemented modules can provide information to, and receive information from, other hardware-implemented modules. Accordingly, the described hardware-implemented modules may be regarded as being communicatively coupled. Where multiple of such hardware-implemented modules exist contemporaneously, communications may be achieved through signal transmission (e.g., over appropriate circuits and buses) that connect the hardware-implemented modules. In embodiments in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation, and store the output of that operation in a memory device to which it is communicatively coupled. A further hardware-implemented module may then, at a later time, access the memory device to retrieve and process the stored output. Hardware-implemented modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., Application Program Interfaces (APIs).)

It is to be understood that the above description is intended to be illustrative, and not restrictive. For example, the above-illustrated embodiments (and/or aspects thereof) may be used in combination with each other. Many other embodiments may be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim.

What is claimed is:

1. A method comprising:
receiving an indication of a search location;
presenting a user interface on a display device of a computing device, the user interface including:
indicia representing a plurality of property listings overlaid on a map according to the search location; and
a list view of the plurality of property listings overlaid on the map,
wherein each property listing in the list view includes an image associated with a property listing of the plurality of property listing;
receiving an input gesture on an image of a first property listing, of the plurality of property listings, in the list view; and in response to receiving the input gesture
presenting a second image of the first property listing in the list view.

2. The method of claim 1, further comprising:
receiving a selection of an indicia representation of a second property listing on the map; and
highlighting a property listing in the list view corresponding to the second property listing.

3. The method of claim 2, wherein highlighting the property listing includes:
extending the second property listing in the list view to cover an additional portion of the map.

4. The method of claim 1, wherein presenting a second image of the first property listing in the list view includes:
overlaying an image counter representing a number of images available for the first property listing.

5. The method of claim 1, further comprising:
receiving an input gesture on the list view; and based on receiving the input gesture; and
expanding the list view to include more than a single column of property listings.

6. The method of claim 5, further comprising:
receiving a selection of an indicia representation of a second property listing on the map; and
scrolling the list view to the property listing corresponding to the second property listing.

7. The method of claim 1, further comprising:
receiving a selection of the first property listing in the list view; and
overlaying a detailed view of the first property listing over the list view such that portions of the map, the list view, and detailed view are visible.

8. A computer-readable storage device comprising instructions stored thereon, which when executed by at least one processor, configure the at least one processor to:
receive an indication of a search location;
present a user interface on a display device of a computing device, the user interface including:
indicia representing a plurality of property listings overlaid on a map according to the search location; and
a list view of the plurality of property listings overlaid on the map,
wherein each property listing in the list view includes an image associated with a property listing of the plurality of property listing;
receive an input gesture on an image of a first property listing, of the plurality of property listings, in the list view; and in response to receiving the input gesture
present a second image of the first property listing in the list view.

9. The computer-readable storage device of claim 8, wherein the instructions, when executed by the at least one processor, configure the at least one processor to:
receive a selection of an indicia representation of a second property listing on the map; and
highlight a property listing in the list view corresponding to the second property listing.

10. The computer-readable storage device of claim 9, wherein the instructions to configure the at least one processor to highlight a property listing in the list view corresponding to the second property listing, configure to at least one processor to:
extend the second property listing in the list view to cover an additional portion of the map.

11. The computer-readable storage device of claim 8, wherein the instructions to configure the at least one processor to present a second image of the first property listing in the list view, configure to at least one processor to:
overlay an image counter representing a number of images available for the first property listing.

12. The computer-readable storage device of claim 8, wherein the instructions, when executed by the at least one processor, configure the at least one processor to:
receive an input gesture on the list view; and based on receiving the input gesture; and
expand the list view to include more than a single column of property listings.

13. The computer-readable storage device of claim 12, wherein the instructions, when executed by the at least one processor, configure the at least one processor to:
receive a selection of an indicia representation of a second property listing on the map; and
scroll the list view to the property listing corresponding to the second property listing.

14. The computer-readable storage device of claim 8, wherein the instructions, when executed by the at least one processor, configure the at least one processor to:
receive a selection of the first property listing in the list view; and
overlay a detailed view of the first property listing over the list view such that portions of the map, the list view, and detailed view are visible.

15. A system comprising:
a memory device comprising instructions stored thereon;
at least one processor, wherein the at least one processor is configured to execute the instructions, based on the execution:
receive an indication of a search location;
present a user interface on a display device of a computing device, the user interface including:
indicia representing a plurality of property listings overlaid on a map according to the search location; and
a list view of the plurality of property listings overlaid on the map, wherein each property listing in the list view includes an image associated with a property listing of the plurality of property listing;
receive an input gesture on an image of a first property listing, of the plurality of property listings, in the list view; and in response to receiving the input gesture
present a second image of the first property listing in the list view.

16. The system of claim 15, wherein the at least one processor is further configured to:
receive a selection of an indicia representation of a second property listing on the map; and
highlight a property listing in the list view corresponding to the second property listing.

17. The system of claim 16, wherein to highlight a property listing in the list view corresponding to the second property listing, the at least one processor is configured to:
extend the second property listing in the list view to cover an additional portion of the map.

18. The system of claim 15, wherein to present a second image of the first property listing in the list view, the at least one processor is configured to:
overlay an image counter representing a number of images available for the first property listing

19. The system of claim 15, wherein the at least one processor is further configured to:
receive an input gesture on the list view; and based on receiving the input gesture; and
expand the list view to include more than a single column of property listings.

20. The system of claim 15, wherein the at least one processor is further configured to:
receive a selection of the first property listing in the list view; and
overlay a detailed view of the first property listing over the list view such that portions of the map, the list view, and detailed view are visible.
